(19) United States
(12) Patent Application Publication
(10) Pub. No.: US 2025/0294616 A1
(43) Pub. Date: Sep. 18, 2025

(54) RANDOM ACCESS USING RESOURCE FOR MULTIPLE OPERATORS

(71) Applicant: QUALCOMM Incorporated, San Diego, CA (US)

(72) Inventors: Kazuki TAKEDA, Minato-ku (JP); Jing LEI, San Diego, CA (US); Kianoush HOSSEINI, San Diego, CA (US); Aleksandar DAMNJANOVIC, Del Mar, CA (US); Aria HASANZADEZONUZY, Jersey City, NJ (US)

(21) Appl. No.: 18/602,755

(22) Filed: Mar. 12, 2024

(51) Int. Cl. H04W 74/0833; H04W 16/14; H04W 74/08

(52) U.S. Cl. CPC H04W 74/0833; H04W 16/14; H04W 74/0866

(57) ABSTRACT

Aspects of the present disclosure relate generally to initial access in shared spectrum. Some aspects more specifically provide shared preamble resources for user equipments (UEs) subscribing to different operators to access shared spectrum. For example, a UE may receive an indication, associated with a first operator, of random access resources. In some examples, the random access resources may be shared between the first operator and the second operator. The UE may transmit a first random access message on a random access resource of the random access resources. Aspects described herein also provide differentiation of random access messages as associated with a first operator or a second operator when a random access preamble has been transmitted on a shared random access resource.

### FIELD OF THE DISCLOSURE

Aspects of the present disclosure generally relate to wireless communication and specifically relate to techniques, apparatuses, and methods associated with random access using a resource for multiple operators.

### BACKGROUND

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

An operator (that is, an entity that implements a network such as a public land mobile network (PLMN) or a non-public network (NPN)), may utilize frequency spectrum (referred to hereinafter as “spectrum”) to implement the network. For example, the operator may license the spectrum from a regulatory authority. In some implementations, spectrum may be shared between a first operator that licenses the spectrum and a second operator that does not license the spectrum. For example, the first operator may be entitled to use the spectrum for communications of the first operator's network, and the second operator can access the spectrum when the spectrum is available (that is, not in use by the first operator). This is referred to as spectrum sharing. Spectrum sharing can be static (such as at the granularity of hours or days) or dynamic (such as at the granularity of seconds, milliseconds, or microseconds), depending on how the operators coordinate with one another.

### SUMMARY

Some aspects described herein relate to a user equipment (UE) for wireless communication. The UE may include a processing system that includes one or more processors and one or more memories coupled with the one or more processors. The processing system may be configured to cause the UE to receive, in association with a first operator, information indicating a random access resource, wherein the UE is associated with a second operator. The processing system may be configured to cause the UE to transmit a first random access message on the random access resource. The processing system may be configured to cause the UE to receive a second random access message. The processing system may be configured to cause the UE to transmit, in association with the second random access message, a third random access message, wherein at least one of the second random access message or the third random access message is associated with an indication of the second operator.

Some aspects described herein relate to a network node for wireless communication. The network node may include a processing system that includes one or more processors and one or more memories coupled with the one or more processors.

The processing system may be configured to cause the network node to transmit information indicating a random access resource shared by a first operator and a second operator. The processing system may be configured to cause the network node to receive a first random access message on the random access resource. The processing system may be configured to cause the network node to transmit a second random access message. The processing system may be configured to cause the network node to receive, in association with the second random access message, a third random access message, wherein at least one of the second random access message or the third random access message is associated with an indication of the second operator. The processing system may be configured to cause the network node to provide the third random access message to a distributed unit associated with the second operator.

Some aspects described herein relate to a method of wireless communication performed by a UE. The method may include receiving, in association with a first operator, information indicating a random access resource, wherein the UE is associated with a second operator. The method may include transmitting a first random access message on the random access resource. The method may include receiving a second random access message. The method may include transmitting, in association with the second random access message, a third random access message, wherein at least one of the second random access message or the third random access message is associated with an indication of the second operator.

Some aspects described herein relate to a method of wireless communication performed by a network node. The method may include transmitting information indicating a random access resource shared by a first operator and a second operator. The method may include receiving a first random access message on the random access resource. The method may include transmitting a second random access message. The method may include receiving, in association with the second random access message, a third random access message, wherein at least one of the second random access message or the third random access message is associated with an indication of the second operator. The method may include providing the third random access message to a distributed unit associated with the second operator.

Some aspects described herein relate to a non-transitory computer-readable medium that stores a set of instructions for wireless communication by a UE. The set of instructions, when executed by one or more processors of the UE, may cause the UE to receive, in association with a first operator, information indicating a random access resource, wherein the UE is associated with a second operator. The set of instructions, when executed by one or more processors of the UE, may cause the UE to transmit a first random access message on the random access resource. The set of instructions, when executed by one or more processors of the UE, may cause the UE to receive a second random access message. The set of instructions, when executed by one or more processors of the UE, may cause the UE to transmit, in association with the second random access message, a third random access message, wherein at least one of the second random access message or the third random access message is associated with an indication of the second operator.

Some aspects described herein relate to a non-transitory computer-readable medium that stores a set of instructions for wireless communication by a network node. The set of instructions, when executed by one or more processors of the network node, may cause the network node to transmit information indicating a random access resource shared by a first operator and a second operator. The set of instructions, when executed by one or more processors of the network node, may cause the network node to receive a first random access message on the random access resource. The set of instructions, when executed by one or more processors of the network node, may cause the network node to transmit a second random access message. The set of instructions, when executed by one or more processors of the network node, may cause the network node to receive, in association with the second random access message, a third random access message, wherein at least one of the second random access message or the third random access message is associated with an indication of the second operator. The set of instructions, when executed by one or more processors of the network node, may cause the network node to provide the third random access message to a distributed unit associated with the second operator.

Some aspects described herein relate to an apparatus for wireless communication. The apparatus may include means for receiving, in association with a first operator, information indicating a random access resource, wherein the apparatus is associated with a second operator. The apparatus may include means for transmitting a first random access message on the random access resource. The apparatus may include means for receiving a second random access message. The apparatus may include means for transmitting, in association with the second random access message, a third random access message, wherein at least one of the second random access message or the third random access message is associated with an indication of the second operator.

Some aspects described herein relate to an apparatus for wireless communication. The apparatus may include means for transmitting information indicating a random access resource shared by a first operator and a second operator. The apparatus may include means for receiving a first random access message on the random access resource. The apparatus may include means for transmitting a second random access message. The apparatus may include means for receiving, in association with the second random access message, a third random access message, wherein at least one of the second random access message or the third random access message is associated with an indication of the second operator. The apparatus may include means for providing the third random access message to a distributed unit associated with the second operator.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network in accordance with the present disclosure.

FIG. 2 is a diagram illustrating an example network node in communication with an example user equipment (UE) in a wireless network in accordance with the present disclosure.

FIG. 3 is a diagram illustrating an example disaggregated base station architecture in accordance with the present disclosure.

FIG. 4 is a diagram illustrating an example of spectrum sharing for multiple operators in accordance with the present disclosure.

FIG. 5 is a diagram illustrating an example of a four-step random access procedure, in accordance with the present disclosure.

FIG. 6 is a diagram illustrating an example of signaling associated with shared random access resources for multiple operators in accordance with the present disclosure.

FIG. 7 is a flowchart illustrating an example process performed, for example, at a UE or an apparatus of a UE that supports random access in shared spectrum in accordance with the present disclosure.

FIG. 8 is a flowchart illustrating an example process performed, for example, at a network node or an apparatus of a network node that supports random access in shared spectrum in accordance with the present disclosure.

FIG. 9 is a diagram of an example apparatus for wireless communication that supports random access in shared spectrum in accordance with the present disclosure.

FIG. 10 is a diagram of an example apparatus for wireless communication that supports random access for shared spectrum in accordance with the present disclosure.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

An operator (that is, an entity that implements a network such as a public land mobile network (PLMN) or a non-public network (NPN)), may utilize frequency spectrum (referred to hereinafter as “spectrum”) to implement the network. For example, the operator may license the spectrum from a regulatory authority. In some implementations, spectrum may be shared between a first operator that licenses the spectrum and a second operator that does not license the spectrum. For example, the first operator may be entitled to use the spectrum for communications of the first operator's network, and the second operator can access the spectrum when the spectrum is available (that is, not in use by the first operator). This is referred to as spectrum sharing. Spectrum sharing can be static (such as at the granularity of hours or days) or dynamic (such as at the granularity of seconds, milliseconds, or microseconds), depending on how the operators coordinate with one another. In some deployments, each operator may implement a respective distributed unit (DU) and a respective radio unit (RU). The first operator's RU (referred to as a first RU) may provide access for spectrum of the first operator. The second operator's DU (referred to as a second DU) may be capable of interfacing with the first operator's RU such that user equipments (UEs) and network nodes associated with the second operator can communicate via the first operator's spectrum. This approach provides spectrum sharing without significant hardware upgrades at the network. Furthermore, implementing spectrum sharing using respective RUs for respective spectra of the operators may enable coverage sharing, in which each RU may cover a respective coverage area and a UE associated with the second operator can access a network of the second operator via the first RU and in a coverage area of the first RU.

Initial access is a process by which a UE establishes an initial connection and gains access to a network. Initial access may include random access, in which a UE transmits a random access preamble to a gNB associated with a cell that the UE has detected. For example, an RU associated with the gNB may transmit synchronization information (such as a synchronization signal block (SSB) on a synchronization channel) and/or system information for a cell. A UE may receive the synchronization information and/or system information, and may transmit the preamble on the cell. The RU may receive the preamble and may provide the preamble to a DU or central unit (CU) associated with the gNB.

Complexity may arise with regard to initial access in the context of spectrum sharing. For example, suppose a UE subscribing to operator 2 is in the coverage of spectrum (for example an RU) for operator 1, and suppose the UE is going to access operator 2's network using the RU and spectrum of operator 1. The UE may monitor synchronization channel(s) (for example SSB(s)) and system information on the spectrum for operator 1, and may acquire a resource for random access preamble transmission from the system information. The synchronization channel(s) and system information on the spectrum for operator 1 is transmitted by the RU of operator 1, and may originate from a CU and/or DU of operator 1 or a CU and/or DU of operator 2. Thus, a preamble received by the RU of operator 1 may be difficult to differentiate as associated with accessing the network of operator 1 or the network of operator 2. One approach is to split resources for preamble transmissions for UEs subscribing to different operators (for example, operator 1 may use a first set of resources and operator 2 may use a second set of resources for preamble transmission to the RU of operator 1). However, splitting resources may involve duplicated resources for preamble transmissions, which involves overhead related to the number of operators sharing the spectrum.

Aspects of the present disclosure relate generally to initial access in shared spectrum. Some aspects more specifically provide shared preamble resources for UEs subscribing to different operators to access shared spectrum. For example, a UE May receive an indication, associated with a first operator, of random access resources. In some examples, the random access resources may be shared between the first operator and the second operator. The UE may transmit a first random access message on a random access resource of the random access resources.

In some examples, system information on spectrum of a first operator may indicate whether a UE associated with a second operator is permitted to use the random access resource. In some examples, the UE may receive a second random access message (such as a random access response or a Msg2). The second random access message may include or otherwise be associated with an indication of an operator associated with the second random access message. Thus, the UE can differentiate whether a DU or CU associated with an operator of the UE has provided a second random access message in response to the first random access message. In some examples, the UE may transmit a third random access message that indicates an operator associated with the UE. For example, the third random access message may identify the operator associated with the UE.

Aspects of the present disclosure may be used to realize one or more of the following potential advantages. In some aspects, by transmitting the first random access message on the shared random access resource, overhead may be reduced and spectral efficiency may be improved. By providing system information that indicates whether a UE associated with a second operator is permitted to use a random access resource provided by an RU of a first operator, random access transmission is reduced with regard to UEs associated with operators that are not permitted to share the spectrum. By providing a second random access message that indicates an operator associated with the second random access message, ambiguity regarding which operator is associated with the second random access message is resolved, thereby enabling shared random access resource configuration and usage. Furthermore, by providing a third random access message that indicates an operator associated with the UE, ambiguities that persist through the first random access message and the second random access message may be resolved (as described in more detail below).

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

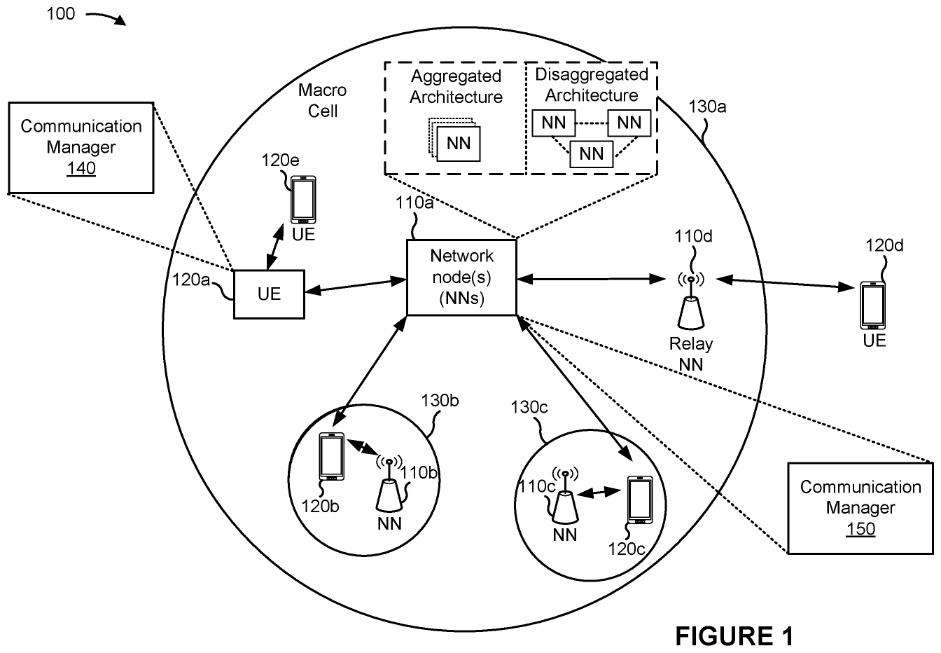

FIG. 1 is a diagram illustrating an example of a wireless communication network 100 in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120c.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHZ), FR2 (24.25 GHz through 52.6 GHZ), FR3 (7.125 GHz through 24.25 GHZ), FR4a or FR4-1 (52.6 GHz through 71 GHZ), FR4 (52.6 GHZ through 114.25 GHZ), and FR5 (114.25 GHz through 300 GHz). Although a portion of FR1 is greater than 6 GHZ, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHz,” if used herein, may broadly refer to frequencies that are less than 6 GHZ, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 May implement dynamic spectrum sharing (DSS), in which multiple RATs (for example, 4G/LTE and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more CUs, one or more DUs, and/or one or more RUs. A CU may host one or more higher layer control functions, such as radio resource control (RRC) functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit downlink control information (DCI) (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more physical uplink control channels (PUCCHs), and uplink data channels may include one or more physical uplink shared channels (PUSCHs). The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In such examples, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (CMTC), UEs, further enhanced cMTC (feMTC) UEs, or enhanced feMTC (efeMTC) UEs, or further evolutions thereof, all of which may be simply referred to as “MTC UEs”. An MTC UE may be, may include, or may be included in or coupled with a robot, an uncrewed aerial vehicle, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, enhanced mobile broadband (cMBB), and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or cMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 120 (for example, shown as UE 120a and UE 120c) may communicate directly with one another using sidelink communications (for example, without communicating by way of a network node 110 as an intermediary). As an example, the UE 120a may directly transmit data, control information, or other signaling as a sidelink communication to the UE 120c. This is in contrast to, for example, the UE 120a first transmitting data in an UL communication to a network node 110, which then transmits the data to the UE 120e in a DL communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve time-division duplexing (TDD), in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive an UL transmission from a second UE 120 in the same time resources. In some other examples, full-duplex operation may be enabled for both a network node 110 and a UE 120.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some RATs may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

In some aspects, the UE 120 may include a communication manager 140. As described in more detail elsewhere herein, the communication manager 140 may receive, in association with a first operator, information indicating a random access resource, wherein the UE is associated with a second operator; transmit a first random access message on the random access resource; receive a second random access message; and transmit, in association with the second random access message, a third random access message, wherein at least one of the second random access message or the third random access message is associated with an indication of the second operator. Additionally or alternatively, the communication manager 140 may perform one or more other operations described herein.

In some aspects, the network node 110 may include a communication manager 150. As described in more detail elsewhere herein, the communication manager 150 may transmit information indicating a random access resource shared by a first operator and a second operator; receive a first random access message on the random access resource; transmit a second random access message; receive, in association with the second random access message, a third random access message, wherein at least one of the second random access message or the third random access message is associated with an indication of the second operator; and provide the third random access message to a distributed unit associated with the second operator. Additionally or alternatively, the communication manager 150 may perform one or more other operations described herein.

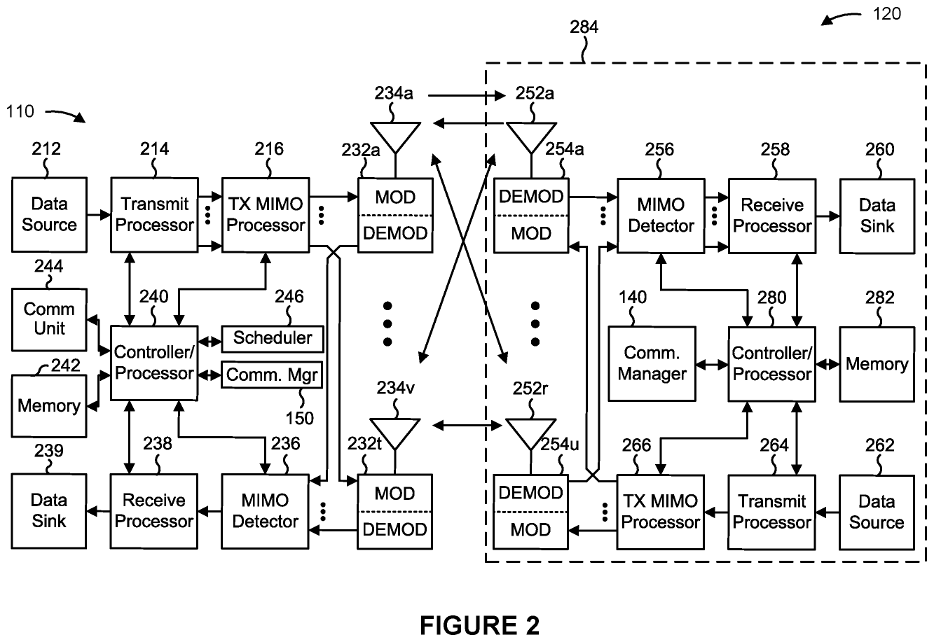

FIG. 2 is a diagram illustrating an example network node 110 in communication with an example UE 120 in a wireless network in accordance with the present disclosure.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more MCSs for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC control element (MAC-CE) communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

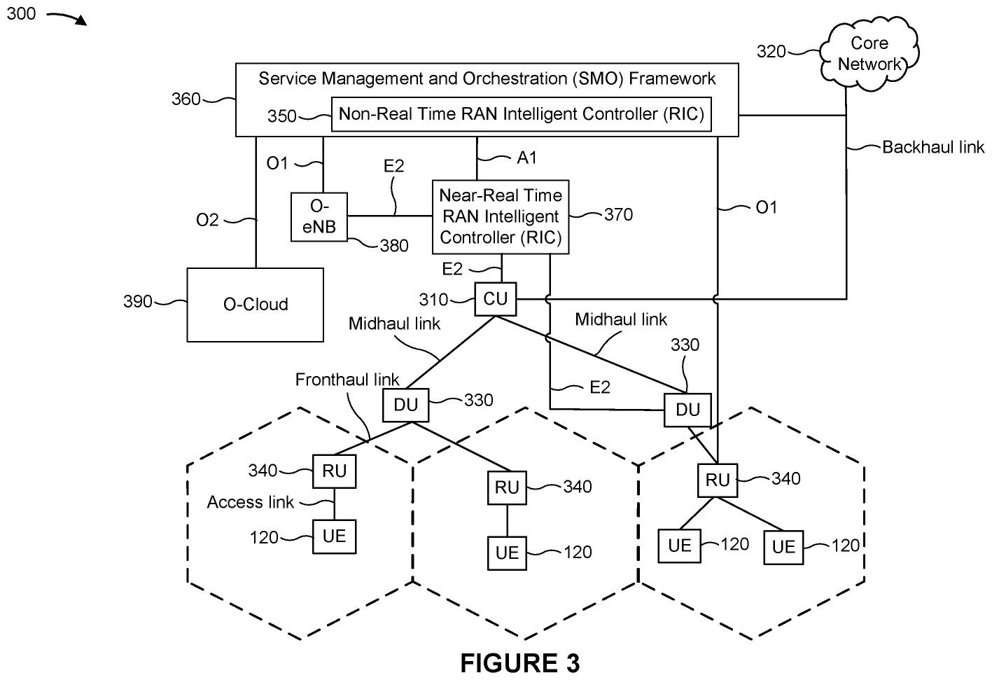

FIG. 3 is a diagram illustrating an example disaggregated base station architecture 300 in accordance with the present disclosure. One or more components of the example disaggregated base station architecture 300 may be, may include, or may be included in one or more network nodes (such one or more network nodes 110). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340.

Each of the components of the disaggregated base station architecture 300, including the CUs 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-eNB) 380, via an O1 interface. Additionally or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, AI/ML workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

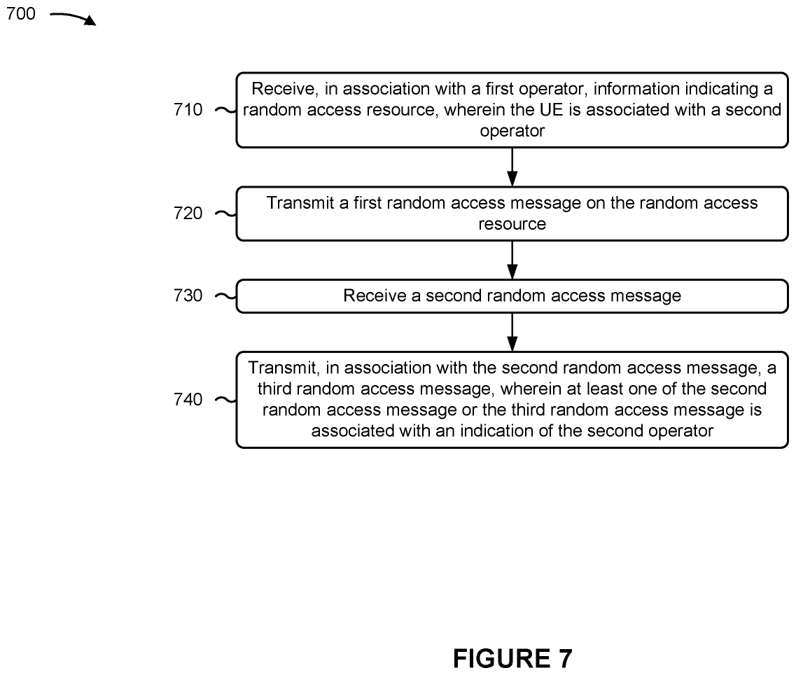

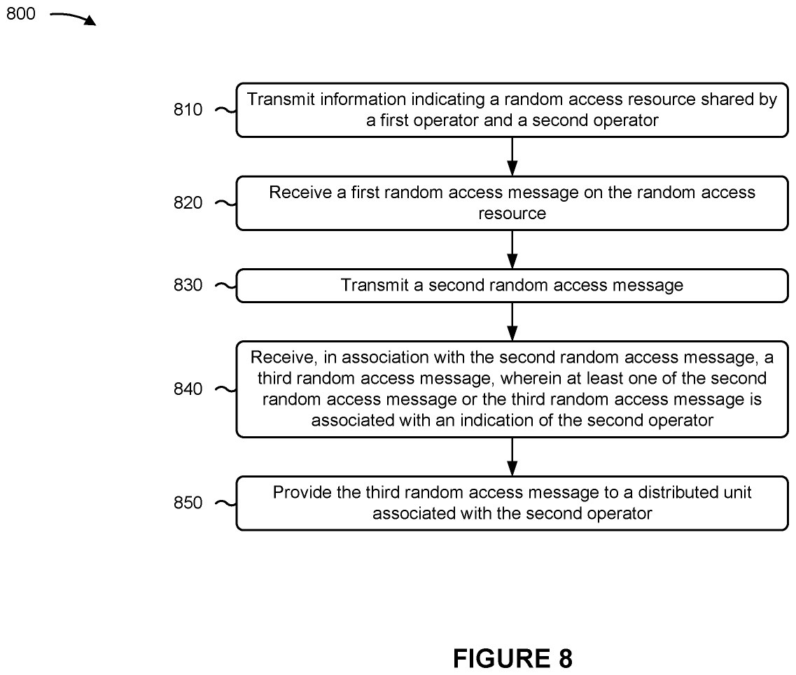

The network node 110, the controller/processor 240 of the network node 110, the UE 120, the controller/processor 280 of the UE 120, the CU 310, the DU 330, the RU 340, or any other component(s) of FIG. 1, 2, or 3 may implement one or more techniques or perform one or more operations associated with random access for shared spectrum, as described in more detail elsewhere herein. For example, the controller/processor 240 of the network node 110, the controller/processor 280 of the UE 120, any other component(s) of FIG. 2, the CU 310, the DU 330, or the RU 340 may perform or direct operations of, for example, process 700 of FIG. 7, process 800 of FIG. 8, or other processes as described herein (alone or in conjunction with one or more other processors). The memory 242 may store data and program codes for the network node 110, the network node 110, the CU 310, the DU 330, or the RU 340. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU 310, the DU 330, or the RU 340, may cause the one or more processors to perform process 700 of FIG. 7, process 800 of FIG. 8, or other processes as described herein. In some examples, executing instructions may include running the instructions, converting the instructions, compiling the instructions, and/or interpreting the instructions, among other examples.

In some aspects, the UE 120 includes means for receiving, in association with a first operator, information indicating a random access resource, wherein the UE 120 is associated with a second operator; means for transmitting a first random access message on the random access resource; means for receiving a second random access message; and/or means for transmitting, in association with the second random access message, a third random access message, wherein at least one of the second random access message or the third random access message is associated with an indication of the second operator. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for transmitting information indicating a random access resource shared by a first operator and a second operator; means for receiving a first random access message on the random access resource; means for transmitting a second random access message; means for receiving, in association with the second random access message, a third random access message, wherein at least one of the second random access message or the third random access message is associated with an indication of the second operator; and/or means for providing the third random access message to a distributed unit associated with the second operator. The means for the network node to perform operations described herein may include, for example, one or more of communication manager 150, transmit processor 214, TX MIMO processor 216, modem 232, antenna 234, MIMO detector 236, receive processor 238, controller/processor 240, memory 242, or scheduler 246.

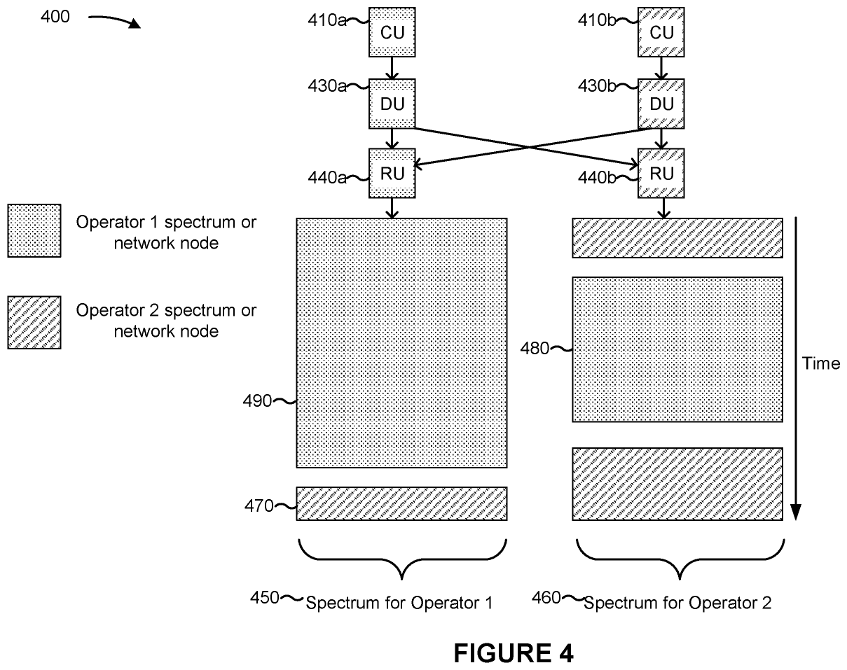

FIG. 4 is a diagram illustrating an example 400 of spectrum sharing for multiple operators in accordance with the present disclosure. Example 400 relates to a first operator (“Operator 1”) and a second operator (“Operator 2”). “Operator,” as used herein, may refer to an entity associated with one or more PLMN identifiers, one or more NPN identifiers, or a network. Spectrum or network nodes associated with the first operator are illustrated with a dotted fill. Spectrum or network nodes associated with the second operator are illustrated with a diagonal hatched fill.

The first operator is associated with a CU 410a (for example, network node 110, CU 310), a DU 430a (for example, network node 110 or DU 330), and an RU 440a (for example, network node 110 or RU 340). The second operator is associated with a CU 410b (for example, network node 110, CU 310), a DU 430b (for example, network node 110 or DU 330), and an RU 440b (for example, network node 110 or RU 340). In example 400, operators share RUs 440 to access spectra of other operators. This is illustrated by an arrow from DU 430a to RU 440b and an arrow from DU 430b to RU 440a. The arrow from DU 430a to RU 440b indicates that the DU 430a may communicate with the RU 440b to facilitate access, by UEs covered by the RU 440b, to a network associated with DU 430a (for example a network associated with the first operator, such as a network having a PLMN identifier or NPN identifier associated with the first operator).

The RU 440a may access or provide coverage in spectrum (such as frequencies) associated with the first operator. This spectrum is shown by reference number 450. The RU 440b may access or provide coverage in spectrum (such as frequencies) associated with the second operator. This spectrum is shown by reference number 460. As shown by reference number 470 and 480, in some time instances, access to a network provided by a given operator can be performed via an RU 440 associated with the other operator. For example, at reference number 470, a network associated with operator 1 can be accessed via RU 440b, as indicated by the diagonal hatched fill included in “spectrum for operator 1” illustrated by reference number 450. Similarly, at reference number 480, a network associated with operator 2 can be accessed via RU 440a, as indicated by the dotted fill included in “spectrum for operator 2” illustrated by reference number 460. Thus, a UE accessing a network associated with operator 1 may communicate with RU 440a during a time interval illustrated by reference number 490, and may communicate with RU 440b during a time interval illustrated by reference number 480. In some examples, spectrum sharing may occur when a given operator is not utilizing spectrum associated with (for example licensed by, controlled by) the given operator. For example, operator 1 may make spectrum associated with operator 1 available at a time interval illustrated by reference number 470 when operator 1 is not utilizing the spectrum.

Spectrum sharing as illustrated in FIG. 4 can be implemented without significant hardware upgrades at the networks. RUs 440 deployed by operators for their respective spectra can be used for spectrum sharing. Furthermore, a UE subscribing to an operator can achieve higher throughput by spectrum aggregation served by different RUs 440. This approach may also enable coverage sharing, in which different operators can support different coverage using their own RUs 440 and spectra. A UE subscribing to operator 1 that is in the coverage of RU 440b of operator 2 may perform initial access (such as random access) to access operator 1's network via RU 440b. Aspects of the present disclosure provide initial access using shared spectrum as illustrated in FIG. 4.

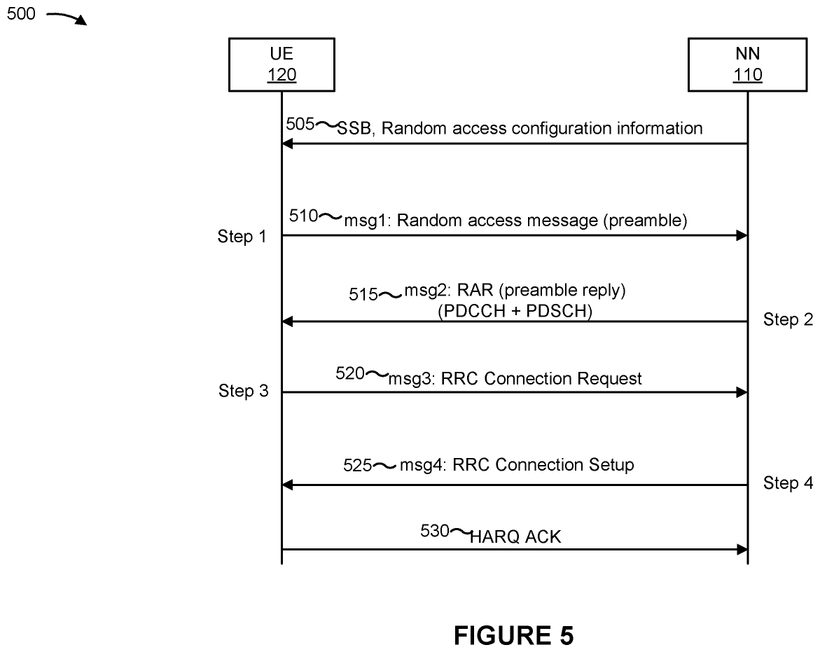

FIG. 5 is a diagram illustrating an example of a four-step random access procedure, in accordance with the present disclosure. As shown in FIG. 5, a network node 110 and a UE 120 may communicate with one another to perform the four-step random access procedure.

The network node 110 of example 500 may include a gNB, which may include a DU (for example DU 330, DU 430) and an RU (for example RU 340, RU 440). In some aspects, the DU and the RU may be associated with a same operator. In some other aspects, the DU may be associated with a first operator and the RU may be associated with a second operator. For example, the DU associated with the first operator may cause the RU to transmit system information relating to accessing a network associated with the first operator, such that the first operator and the second operator can implement spectrum sharing via the RU.

As shown by FIG. 5, in a first operation 505, the network node 110 may transmit, and the UE 120 may receive, one or more SSBs and random access configuration information. In some aspects, the random access configuration information may be transmitted in and/or indicated by system information (for example in one or more system information blocks (SIBs)) and/or an SSB, such as for contention-based random access. Additionally or alternatively, the random access configuration information may be transmitted in an RRC message and/or a PDCCH order message that triggers a random access channel (RACH) procedure, such as for contention-free random access. The random access configuration information may include one or more parameters to be used in the random access procedure, such as one or more parameters for transmitting a random access message (RAM) and/or one or more parameters for receiving a random access response (RAR).

In a second operation 510, the UE 120 may transmit a RAM, which may include a preamble (sometimes referred to as a random access preamble, a PRACH preamble, or a RAM preamble). The message that includes the preamble may be referred to as a message 1, msg1, MSG1, a first random access message, or an initial message in a four-step random access procedure. The random access message may include a random access preamble identifier.

In a third operation 515, the network node 110 may transmit an RAR as a reply to the preamble. The message that includes the RAR may be referred to as message 2, msg2, MSG2, or a second random access message in a four-step random access procedure. In some aspects, the RAR may indicate the detected random access preamble identifier (for example received from the UE 120 in msg1). Additionally or alternatively, the RAR may indicate a resource allocation to be used by the UE 120 to transmit message 3 (msg3).

In some aspects, as part of the second step of the four-step random access procedure, the network node 110 may transmit a PDCCH communication for the RAR. The PDCCH communication may schedule a PDSCH communication that includes the RAR. For example, the PDCCH communication may indicate a resource allocation for the PDSCH communication. Also as part of the second step of the four-step random access procedure, the network node 110 may transmit the PDSCH communication for the RAR, as scheduled by the PDCCH communication. The RAR may be included in a MAC protocol data unit of the PDSCH communication.

In a fourth operation 520, the UE 120 may transmit an RRC connection request message. The RRC connection request message may be referred to as message 3, msg3, MSG3, or a third random access message of a four-step random access procedure. In some aspects, the RRC connection request may include a UE identifier, UCI, and/or a PUSCH communication (for example an RRC connection request).

In a fifth operation 525, the network node 110 may transmit an RRC connection setup message. The RRC connection setup message may be referred to as message 4, msg4, MSG4, or a fourth message of a four-step random access procedure.

In some aspects, the RRC connection setup message may include the detected UE identifier, a timing advance value, and/or contention resolution information. In a sixth operation 530, if the UE 120 successfully receives the RRC connection setup message, the UE 120 may transmit a hybrid automatic repeat request (HARQ) acknowledgment (ACK).

In some aspects described herein, the second random access message in the third operation 515 or the third random access message in the fourth operation 520 may include an indication of an operator associated with the UE 120. Additionally or alternatively, the SSB in the first operation 505 may include an indication of the operator.

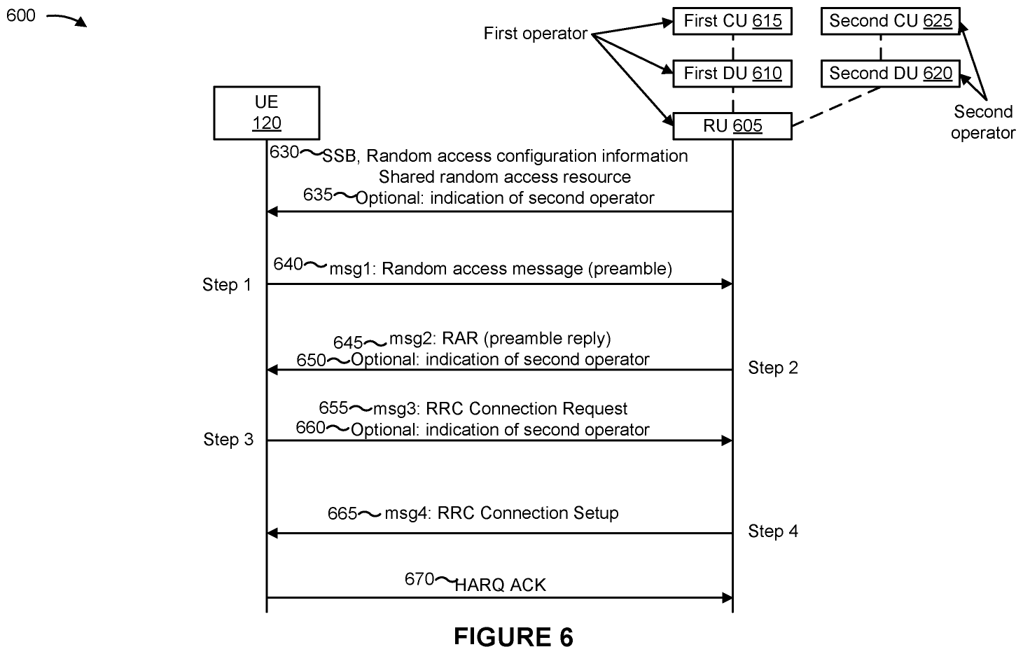

FIG. 6 is a diagram illustrating an example 600 of signaling associated with shared random access resources for multiple operators in accordance with the present disclosure. Example 600 includes a UE 120 and an RU 605 (such as network node 110, RU 340, or RU 440). The RU 605 may be associated with a first operator. Example 600 also illustrates a first DU 610 (such as network node 110, DU 330, or DU 430) and a first CU 615 (such as network node 110, CU 310, or CU 410) that are associated with the first operator, and a second DU 620 (such as network node 110, DU 330, or DU 430) and a second CU 625 (such as network node 110, CU 310, or CU 410) that are associated with a second operator different than the first operator. The UE 120 may be associated with the second operator. For example, the UE 120 may be a subscriber of the second operator. Thus, the UE 120 may access a network associated with (such as provided by) the second DU 620 and/or the second CU 625 via the RU 605. Thus, the RU 605 may implement spectrum sharing with regard to the first operator or the second operator.

As shown by FIG. 6, in a first operation 630, the RU 605 may transmit, and the UE 120 may receive, one or more SSBs and random access configuration information. In some aspects, the random access configuration information may be transmitted in and/or indicated by system information (for example in one or more SIBs) and/or an SSB, such as for contention-based random access. Additionally or alternatively, the random access configuration information may be transmitted in an RRC message and/or a PDCCH order message that triggers a RACH procedure, such as for contention-free random access. The RU 605 may transmit the one or more SSBs and random access configuration information on spectrum associated with the first operator (such as licensed by the first operator).

As shown, the system information (or the random access configuration information, or the SSB) may indicate shared random access resources. A shared random access resource is a resource on which both a random access message associated with a first operator and a random access message associated with a second operator can be transmitted. The random access message may include any message described with regard to FIG. 6, such as the first random access message 640, the second random access message 645, or the third random access message 655.

In some aspects, the shared random access resource may include resources for random access preamble transmission. UEs subscribing to the first operator (such as UEs associated with a network that is associated with the first CU 615 and/or the first DU 610) and the UE 120 subscribing to the second operator may receive (such as read) the system information and acquire the resources for random access preamble transmission. In some examples, these UEs may all be permitted to transmit a first random access message on the resources for random access preamble transmission.

As shown, in some aspects, the system information (or the random access configuration information, or the SSB) may include an indication 635 of the second operator. For example, the indication 635 may indicate a set of operators for which random access preamble transmission on the resources for random access preamble transmission is permitted. For example, the indication 635 may indicate a set of PLMN identifiers, a set of NPN identifiers, or another form of identifier associated with an operator.

In some aspects, the indication 635 may be separate from cell access related information of the system information (or the random access configuration information, or the SSB). The cell access related information may indicate a set of PLMN identifiers and/or NPN identifiers that can perform initial access via the RU 605 for the purpose of roaming or multiple operator core network sharing (MOCN), such that random access on the first operator's spectrum is processed by the first CU 615 or the first DU 610. The cell access related information may be indicated by a parameter cellAccessRelatedInfo defined in a wireless communication specification. In contrast, the indication 635 may indicate one or more operators that are permitted to transmit a random access preamble to the RU 605 for the purpose of accessing a network associated with the second operator. In this example, the random access preamble or random access message may be processed by the second DU 620 and/or the second CU 625. In some aspects, the system information, random access configuration information, or SSB may include both the indication 635 and the cell access related information.

In a second operation, the UE 120 may transmit, and the RU 605 may receive, a first random access message 640, which may include a preamble (sometimes referred to as a random access preamble, a PRACH preamble, or a RAM preamble). For example, the UE 120 may transmit the first random access message 640 (for example, msg1) in response to the indication 635 indicating the second operator. The first random access message 640 may include a random access preamble identifier. In some aspects, multiple DUs and/or CUs associated with different operators may detect the first random access message 640. For example, the first DU 610 and the second DU 620 may both detect the first random access message 640. As another example, the first CU 615 and the second CU 625 may both detect the first random access message 640. Aspects described herein provide differentiation of whether a response to the first random access message 640 is associated with (such as provided by) a DU or CU associated with the first operator or a DU or CU associated with the second operator.

In a third operation, the RU 605 may transmit a second random access message 645 (for example, msg 2), shown as an RAR, as a reply to the first random access message 640. In some aspects, the second random access message 645 may indicate the detected random access preamble identifier (for example received from the UE 120 in msg1). Additionally or alternatively, the second random access message 645 may indicate a resource allocation to be used by the UE 120 to transmit a third random access message 655 (msg3).

In some aspects, as part of the second step of the four-step random access procedure, the RU 605 may transmit a PDCCH communication for the second random access message 645. The PDCCH communication may schedule a PDSCH communication that includes the second random access message 645. For example, the PDCCH communication may indicate a resource allocation for the PDSCH communication. Also as part of the second step of the four-step random access procedure, the RU 605 may transmit the PDSCH communication for the second random access message 645, as scheduled by the PDCCH communication. The second random access message 645 may be included in a MAC protocol data unit of the PDSCH communication.

As mentioned, in some examples, multiple DUs/CUs may transmit or trigger transmission of a second random access message 645. For example, the RU 605 may be unable to distinguish whether the first random access message 640 is associated with the first operator or the second operator (whether the first random access message 640 is transmitted by a UE that subscribes to the first operator or the second operator). In this situation, multiple sets of DUs/CUs may monitor a resource for random access, and may transmit or trigger transmission of a second random access message 645 in response to the first random access message 640 on the resource for random access. The UE 120 may receive each of these second random access messages 645.

As shown, in some examples, the second random access message 645 may include an indication 650 of the second operator. For example, the indication 650 may identify one or more operators that transmitted or triggered transmission of the second random access message 645.

In some aspects, the indication 650 may indicate one or more identifiers of the one or more operators, such as one or more PLMN identifiers or one or more NPN identifiers. The UE 120 receiving the indication 650 may check the one or more PLMN identifiers and/or the one or more NPN identifiers, and if the UE 120 identifies a match to the UE 120's subscription or to the UE 120's random-access cause, the UE 120 may process the second random access message 645 and/or transmit a third random access message 655 in accordance with an RAR grant. A subscription may indicate that the UE 120 is associated with the second operator. On the spectrum for the first operator, the one or more PLMN identifiers and/or the one or more NPN identifiers in the second random access message 645 from the first DU 610 or the first CU 615 of the first operator may be similar to the one or more PLMN identifiers and/or the one or more NPN identifiers in the system information transmitted on the spectrum for operator 1 (in the first operation 630). On the spectrum for the first operator, the one or more PLMN identifiers and/or the one or more NPN identifiers in the second random access message 645 from the second DU 620 and/or the second CU 625 of the second operator may differ from the one or more PLMN identifiers and/or the one or more NPN identifiers in the system information transmitted on the spectrum for the first operator (in the first operation 630). In some aspects, if the second random access message 645 does not include the indication 650, the UE 120 may consider the second random access message 645 to be transmitted from the same operator that transmits or triggers transmission of the system information (in the first operation 630). This could save overhead by defining a default PLMN identifier list and/or NPN identifier list. A PLMN identifier may be referred to as a network identifier. An NPN identifier may be referred to as a network identifier.

In some aspects, the indication 650 may include a sharing identifier. A sharing identifier is an identifier that is associated with a set of operators, such as a set of network identifiers corresponding to the set of operators. Because the number of operators sharing spectrum is typically not large (for example, 2 operators, 3 operators, or 4 operators), the sharing identifier may reduce overhead relative to explicitly including network identifiers. In some aspects, system information received by the UE 120 in the first operation 630 may indicate an association between the sharing identifier and the set of operators. The UE 120 may identify the sharing identifier, and if the UE 120 identifies a match to the UE 120's subscription or to the UE 120's random-access cause, the UE 120 may process the second random access message 645 and/or transmit a third random access message 655 in accordance with an RAR grant. In some aspects, if the second random access message 645 does not include the sharing identifier, the UE 120 may consider the second random access message 645 to be transmitted from the same operator that transmits or triggers transmission of the system information in the first operation 630. This could save overhead by defining a default PLMN identifier list and/or NPN identifier list.

In some aspects, the indication 650 may include an implicit indication of the second operator. The implicit indication may include at least one of a DMRS sequence or a radio network temporary identifier (RNTI). For example, a first DMRS sequence may be associated with a first operator and a second DMRS sequence may be associated with a second operator. As another example, a first value of an RNTI may be associated with a first operator and a second value of an RNTI may be associated with a second operator. Mappings between these operators and implicit indications may be defined by a wireless communication specification, or may be configured (such as via RRC signaling which may include system information).

In a fourth operation, the UE 120 may transmit, and the RU 605 may receive, a third random access message 655 (for example, msg 3) which may include an RRC connection request message. For example, the UE 120 may transmit the third random access message 655 upon successful decoding of the second random access message 645 and identifying the second operator associated with the second random access message 645. In some aspects, the RRC connection request may include a UE identifier, UCI, and/or a PUSCH communication (for example an RRC connection request).

As shown, in some aspects, the third random access message 655 may include an indication 660 that indicates the second operator. This indication 660 may resolve ambiguity regarding whether the third random access message 655 is associated with the first operator or the second operator. This ambiguity may occur in a situation where (1) multiple UEs associated with different operators transmit a random access (RA) preamble at the same time; (2) multiple sets of DUs/CUs from different operators respond with a second random access message, both of which trigger Msg3 transmission on the same resource; and (3) one or more UEs that have transmitted an RA preamble at the same time also transmit a third random access message at the same time. The indication 660 may include any information that was provided in the indication 650, such as a sharing identifier, a network identifier, or an implicit indication.

In a fifth operation 665, the RU 605 may transmit an RRC connection setup message. The RRC connection setup message may be referred to as message 4, msg4, MSG4, or a fourth message of a four-step random access procedure. In some aspects, the RRC connection setup message may include the detected UE identifier, a timing advance value, and/or contention resolution information. In a sixth operation 670, if the UE 120 successfully receives the RRC connection setup message, the UE 120 may transmit a HARQ ACK.

FIG. 7 is a flowchart illustrating an example process 700 performed, for example, at a UE or an apparatus of a UE that supports random access in shared spectrum in accordance with the present disclosure. Example process 700 is an example where the apparatus or the UE (for example, UE 120) performs operations associated with random access using a shared random access resource for multiple operators.

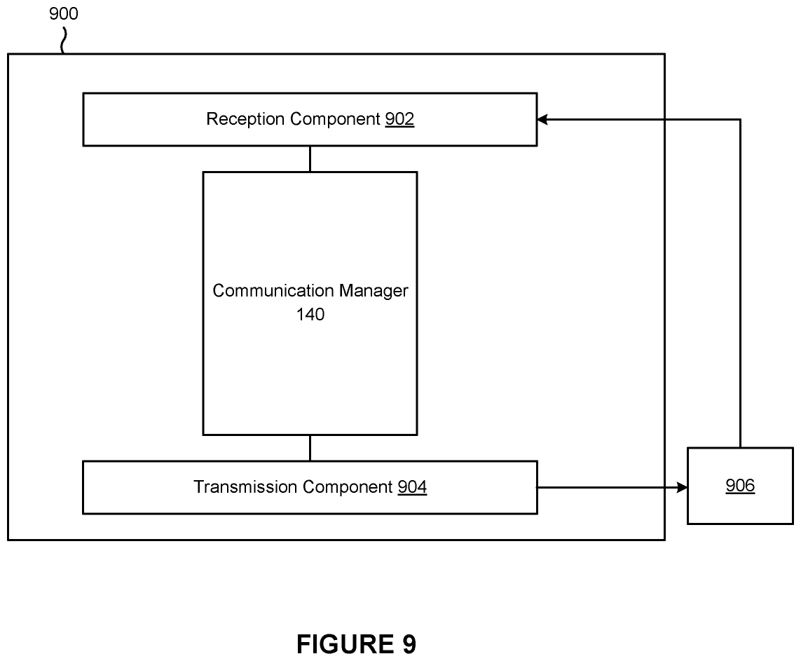

As shown in FIG. 7, in some aspects, process 700 may include receiving, in association with a first operator, information indicating a random access resource, wherein the UE is associated with a second operator (block 710). For example, the UE (such as by using communication manager 140 or reception component 902, depicted in FIG. 9) may receive, in association with a first operator, information indicating a random access resource, wherein the UE is associated with a second operator, as described above.

As further shown in FIG. 7, in some aspects, process 700 may include transmitting a first random access message on the random access resource (block 720). For example, the UE (such as by using communication manager 140 or transmission component 904, depicted in FIG. 9) may transmit a first random access message on the random access resource, as described above.

As further shown in FIG. 7, in some aspects, process 700 may include receiving a second random access message (block 730). For example, the UE (such as by using communication manager 140 or reception component 902, depicted in FIG. 9) may receive a second random access message, as described above.

As further shown in FIG. 7, in some aspects, process 700 may include transmitting, in association with the second random access message, a third random access message, wherein at least one of the second random access message or the third random access message is associated with an indication of the second operator (block 740). For example, the UE (such as by using communication manager 140 or transmission component 904, depicted in FIG. 9) may transmit, in association with the second random access message, a third random access message, wherein at least one of the second random access message or the third random access message is associated with an indication of the second operator, as described above.

Process 700 may include additional aspects, such as any single aspect or any combination of aspects described below or in connection with one or more other processes described elsewhere herein.

In a first additional aspect, the information indicating the random access resource comprises system information on a spectrum associated with the first operator.

In a second additional aspect, alone or in combination with the first aspect, the system information includes an indication that the second operator is permitted to use the random access resource.

In a third additional aspect, alone or in combination with one or more of the first and second aspects, the indication that the second operator is permitted to use the random access resource is separate from cell access related information of the system information.

In a fourth additional aspect, alone or in combination with one or more of the first through third aspects, receiving the second random access message comprises receiving a first second random access message associated with the first operator and a second second random access message associated with the second operator, wherein the second second random access message includes the indication of the second operator.

In a fifth additional aspect, alone or in combination with one or more of the first through fourth aspects, transmitting the third random access message comprises transmitting the third random access message, in response to the second second random access message, in association with the second second random access message including the indication of the second operator.

In a sixth additional aspect, alone or in combination with one or more of the first through fifth aspects, the indication of the second operator comprises a set of network identifiers, wherein the set of network identifiers indicates the second operator.

In a seventh additional aspect, alone or in combination with one or more of the first through sixth aspects, a network identifier, of the set of network identifiers, matches a subscription or a random access cause of the UE.

In an eighth additional aspect, alone or in combination with one or more of the first through seventh aspects, the indication of the second operator comprises an identifier that is associated with a set of network identifiers, wherein the set of network identifiers indicates the second operator.

In a ninth additional aspect, alone or in combination with one or more of the first through eighth aspects, process 700 includes receiving information that indicates a mapping between the identifier and the set of network identifiers.

In a tenth additional aspect, alone or in combination with one or more of the first through ninth aspects, the indication of the second operator comprises an implicit indication of the second operator.

In an eleventh additional aspect, alone or in combination with one or more of the first through tenth aspects, the implicit indication comprises at least one of a demodulation reference signal sequence or a radio network temporary identifier.

In a twelfth additional aspect, alone or in combination with one or more of the first through eleventh aspects, process 700 includes receiving information that indicates a mapping between the implicit indication and the second operator.

In a thirteenth additional aspect, alone or in combination with one or more of the first through twelfth aspects, the random access resource is shared by the first operator and the second operator.

Although FIG. 7 shows example blocks of process 700, in some aspects, process 700 may include additional blocks, fewer blocks, different blocks, or differently arranged blocks than those depicted in FIG. 7. Additionally or alternatively, two or more of the blocks of process 700 may be performed in parallel.

FIG. 8 is a flowchart illustrating an example process 800 performed, for example, at a network node or an apparatus of a network node that supports random access in shared spectrum in accordance with the present disclosure. Example process 800 is an example where the apparatus or the network node (for example, network node 110) performs operations associated with random access using a shared random access resource for multiple operators.

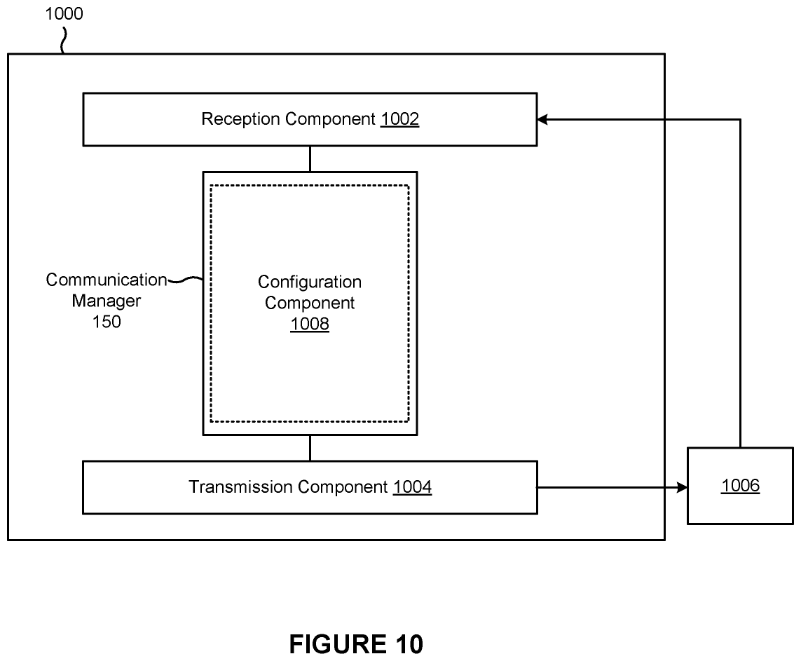

As shown in FIG. 8, in some aspects, process 800 may include transmitting information indicating a random access resource shared by a first operator and a second operator (block 810). For example, the network node (such as by using communication manager 150 or transmission component 1004, depicted in FIG. 10) may transmit information indicating a random access resource shared by a first operator and a second operator, as described above.

As further shown in FIG. 8, in some aspects, process 800 may include receiving a first random access message on the random access resource (block 820). For example, the network node (such as by using communication manager 150 or reception component 1002, depicted in FIG. 10) may receive a first random access message on the random access resource, as described above.

As further shown in FIG. 8, in some aspects, process 800 may include transmitting a second random access message (block 830). For example, the network node (such as by using communication manager 150 or transmission component 1004, depicted in FIG. 10) may transmit a second random access message, as described above.

As further shown in FIG. 8, in some aspects, process 800 may include receiving, in association with the second random access message, a third random access message, wherein at least one of the second random access message or the third random access message is associated with an indication of the second operator (block 840). For example, the network node (such as by using communication manager 150 or reception component 1002, depicted in FIG. 10) may receive, in association with the second random access message, a third random access message, wherein at least one of the second random access message or the third random access message is associated with an indication of the second operator, as described above.

As further shown in FIG. 8, in some aspects, process 800 may include providing the third random access message to a distributed unit associated with the second operator (block 850). For example, the network node (such as by using communication manager 150, transmission component 1004, depicted in FIG. 10, or a network interface) may provide the third random access message to a distributed unit associated with the second operator, as described above.

Process 800 may include additional aspects, such as any single aspect or any combination of aspects described below or in connection with one or more other processes described elsewhere herein.

In a first additional aspect, the information indicating the random access resource comprises system information on a spectrum associated with the first operator.

In a second additional aspect, alone or in combination with the first aspect, the system information includes an indication that the second operator is permitted to use the random access resource.

In a third additional aspect, alone or in combination with one or more of the first and second aspects, the indication that the second operator is permitted to use the random access resource is separate from cell access related information of the system information.

In a fourth additional aspect, alone or in combination with one or more of the first through third aspects, transmitting the second random access message comprises transmitting a first second random access message associated with the first operator and a second second random access message associated with the second operator, wherein the second second random access message includes the indication of the second operator.

In a fifth additional aspect, alone or in combination with one or more of the first through fourth aspects, receiving the third random access message comprises receiving the third random access message in association with the second second random access message including the indication of the second operator.

In a sixth additional aspect, alone or in combination with one or more of the first through fifth aspects, the indication of the second operator comprises a set of network identifiers, wherein the set of network identifiers indicates the second operator.

In a seventh additional aspect, alone or in combination with one or more of the first through sixth aspects, the indication of the second operator comprises an identifier that is associated with a set of network identifiers, wherein the set of network identifiers indicates the second operator.

In an eighth additional aspect, alone or in combination with one or more of the first through seventh aspects, process 800 includes transmitting information that indicates a mapping between the identifier and the set of network identifiers.

In a ninth additional aspect, alone or in combination with one or more of the first through eighth aspects, the indication of the second operator comprises an implicit indication of the second operator.

In a tenth additional aspect, alone or in combination with one or more of the first through ninth aspects, the implicit indication comprises at least one of a demodulation reference signal sequence or a radio network temporary identifier.

In an eleventh additional aspect, alone or in combination with one or more of the first through tenth aspects, process 800 includes transmitting information that indicates a mapping between the implicit indication and the second operator.

In a twelfth additional aspect, alone or in combination with one or more of the first through eleventh aspects, transmitting the information indicating the random access resource is in response to a trigger, associated with the first operator, to transmit the information indicating the random access resource.

Although FIG. 8 shows example blocks of process 800, in some aspects, process 800 may include additional blocks, fewer blocks, different blocks, or differently arranged blocks than those depicted in FIG. 8. Additionally or alternatively, two or more of the blocks of process 800 may be performed in parallel.

FIG. 9 is a diagram of an example apparatus 900 for wireless communication that supports random access in shared spectrum in accordance with the present disclosure. The apparatus 900 may be a UE, or a UE may include the apparatus 900. In some aspects, the apparatus 900 includes a reception component 902, a transmission component 904, and a communication manager 140, which may be in communication with one another (for example, via one or more buses). As shown, the apparatus 900 may communicate with another apparatus 906 (such as a UE, a network node, or another wireless communication device) using the reception component 902 and the transmission component 904.

In some aspects, the apparatus 900 may be configured to and/or operable to perform one or more operations described herein in connection with FIGS. 4, 5, and 6. Additionally or alternatively, the apparatus 900 may be configured to and/or operable to perform one or more processes described herein, such as process 700 of FIG. 7. In some aspects, the apparatus 900 may include one or more components of the UE described above in connection with FIG. 2.

The reception component 902 may receive communications, such as reference signals, control information, and/or data communications, from the apparatus 906. The reception component 902 may provide received communications to one or more other components of the apparatus 900, such as the communication manager 140. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 902 may include one or more antennas, one or more modems, one or more demodulators, one or more MIMO detectors, one or more receive processors, one or more controllers/processors, and/or one or more memories of the UE described above in connection with FIG. 2.

The transmission component 904 may transmit communications, such as reference signals, control information, and/or data communications, to the apparatus 906. In some aspects, the communication manager 140 may generate communications and may transmit the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, one or more modems, one or more modulators, one or more transmit MIMO processors, one or more transmit processors, one or more controllers/processors, and/or one or more memories of the UE described above in connection with FIG. 2. In some aspects, the transmission component 904 may be co-located with the reception component 902 in one or more transceivers.

The communication manager 140 may receive or may cause the reception component 902 to receive, in association with a first operator, information indicating a random access resource, wherein the UE is associated with a second operator. The communication manager 140 may transmit or may cause the transmission component 904 to transmit a first random access message on the random access resource. The communication manager 140 may receive or may cause the reception component 902 to receive a second random access message. The communication manager 140 may transmit or may cause the transmission component 904 to transmit, in association with the second random access message, a third random access message, wherein at least one of the second random access message or the third random access message is associated with an indication of the second operator. In some aspects, the communication manager 140 may perform one or more operations described elsewhere herein as being performed by one or more components of the communication manager 140.

The communication manager 140 may include one or more controllers/processors and/or one or more memories, of the UE described above in connection with FIG. 2. Additionally or alternatively, the communication manager 140 may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive, in association with a first operator, information indicating a random access resource, wherein the UE is associated with a second operator. The transmission component 904 may transmit a first random access message on the random access resource. The reception component 902 may receive a second random access message. The transmission component 904 may transmit, in association with the second random access message, a third random access message, wherein at least one of the second random access message or the third random access message is associated with an indication of the second operator.

The reception component 902 may receive information that indicates a mapping between the identifier and the set of network identifiers.

The reception component 902 may receive information that indicates a mapping between the implicit indication and the second operator.

FIG. 10 is a diagram of an example apparatus 1000 for wireless communication that supports RA for shared spectrum in accordance with the present disclosure. The apparatus 1000 may be a network node such as an RU, or a network node such as an RU may include the apparatus 1000. In some aspects, the apparatus 1000 includes a reception component 1002, a transmission component 1004, and a communication manager 150, which may be in communication with one another (for example, via one or more buses). As shown, the apparatus 1000 may communicate with another apparatus 1006 (such as a UE, a network node, or another wireless communication device) using the reception component 1002 and the transmission component 1004.

In some aspects, the apparatus 1000 may be configured to and/or operable to perform one or more operations described herein in connection with FIGS. 4, 5, and 6. Additionally or alternatively, the apparatus 1000 may be configured to and/or operable to perform one or more processes described herein, such as process 800 of FIG. 8. In some aspects, the apparatus 1000 may include one or more components of the network node described above in connection with FIG. 2.

The reception component 1002 may receive communications, such as reference signals, control information, and/or data communications, from the apparatus 1006. The reception component 1002 may provide received communications to one or more other components of the apparatus 1000, such as the communication manager 150. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 1002 may include one or more antennas, one or more modems, one or more demodulators, one or more MIMO detectors, one or more receive processors, one or more controllers/processors, and/or one or more memories of the network node described above in connection with FIG. 2.

The transmission component 1004 may transmit communications, such as reference signals, control information, and/or data communications, to the apparatus 1006. In some aspects, the communication manager 150 may generate communications and may transmit the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, one or more modems, one or more modulators, one or more transmit MIMO processors, one or more transmit processors, one or more controllers/processors, and/or one or more memories of the network node described above in connection with FIG. 2. In some aspects, the transmission component 1004 may be co-located with the reception component 1002 in one or more transceivers.

The communication manager 150 may transmit or may cause the transmission component 1004 or the configuration component 1008 to transmit information indicating a random access resource shared by a first operator and a second operator. The communication manager 150 may receive or may cause the reception component 1002 to receive a first random access message on the random access resource. The communication manager 150 may transmit or may cause the transmission component 1004 to transmit a second random access message. The communication manager 150 may receive or may cause the reception component 1002 to receive, in association with the second random access message, a third random access message, wherein at least one of the second random access message or the third random access message is associated with an indication of the second operator. The communication manager 150 may provide the third random access message to a distributed unit associated with the second operator. In some aspects, the communication manager 150 may perform one or more operations described elsewhere herein as being performed by one or more components of the communication manager 150.

The communication manager 150 may include one or more controllers/processors, one or more memories, one or more schedulers, and/or one or more communication units of the network node described above in connection with FIG. 2. In some aspects, the communication manager 150 includes a set of components, such as a configuration component 1008. Alternatively, the set of components may be separate and distinct from the communication manager 150. In some aspects, one or more components of the set of components may include or may be implemented within one or more controllers/processors, one or more memories, one or more schedulers, and/or one or more communication units of the network node described above in connection with FIG. 2. Additionally or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The transmission component 1004 or the configuration component 1008 may transmit information indicating a random access resource shared by a first operator and a second operator. The reception component 1002 may receive a first random access message on the random access resource. The transmission component 1004 may transmit a second random access message. The reception component 1002 may receive, in association with the second random access message, a third random access message, wherein at least one of the second random access message or the third random access message is associated with an indication of the second operator. The transmission component 1004 may provide the third random access message to a distributed unit associated with the second operator.

The transmission component 1004 may transmit information that indicates a mapping between the identifier and the set of network identifiers.

The transmission component 1004 may transmit information that indicates a mapping between the implicit indication and the second operator.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally or alternatively, a set of (one or more) components shown in FIG. 10 may perform one or more functions described as being performed by another set of components shown in FIG. 10.

The following provides an overview of some Aspects of the present disclosure:

Aspect 1: A method of wireless communication performed by a user equipment (UE), comprising: receiving, in association with a first operator, information indicating a random access resource, wherein the UE is associated with a second operator; transmitting a first random access message on the random access resource; receiving a second random access message; and transmitting, in association with the second random access message, a third random access message, wherein at least one of the second random access message or the third random access message is associated with an indication of the second operator.

Aspect 2: The method of Aspect 1, wherein the information indicating the random access resource comprises system information on a spectrum associated with the first operator.

Aspect 3: The method of Aspect 2, wherein the system information includes an indication that the second operator is permitted to use the random access resource.

Aspect 4: The method of Aspect 3, wherein the indication that the second operator is permitted to use the random access resource is separate from cell access related information of the system information.

Aspect 5: The method of any of Aspects 1-4, wherein receiving the second random access message comprises receiving a first second random access message associated with the first operator and a second second random access message associated with the second operator, wherein the second second random access message includes the indication of the second operator.

Aspect 6: The method of Aspect 5, wherein transmitting the third random access message comprises transmitting the third random access message, in response to the second second random access message, in association with the second second random access message including the indication of the second operator.

Aspect 7: The method of any of Aspects 1-6, wherein the indication of the second operator comprises a set of network identifiers, wherein the set of network identifiers indicates the second operator.

Aspect 8: The method of Aspect 7, wherein a network identifier, of the set of network identifiers, matches a subscription or a random access cause of the UE.

Aspect 9: The method of any of Aspects 1-8, wherein the indication of the second operator comprises an identifier that is associated with a set of network identifiers, wherein the set of network identifiers indicates the second operator.

Aspect 10: The method of Aspect 9, further comprising receiving information that indicates a mapping between the identifier and the set of network identifiers.

Aspect 11: The method of any of Aspects 1-10, wherein the indication of the second operator comprises an implicit indication of the second operator.

Aspect 12: The method of Aspect 11, wherein the implicit indication comprises at least one of a demodulation reference signal sequence or a radio network temporary identifier.

Aspect 13: The method of Aspect 11, further comprising receiving information that indicates a mapping between the implicit indication and the second operator.

Aspect 14: The method of any of Aspects 1-13, wherein the random access resource is shared by the first operator and the second operator.

Aspect 15: A method of wireless communication performed by a network node, comprising: transmitting information indicating a random access resource shared by a first operator and a second operator; receiving a first random access message on the random access resource; transmitting a second random access message; receiving, in association with the second random access message, a third random access message, wherein at least one of the second random access message or the third random access message is associated with an indication of the second operator; and providing the third random access message to a distributed unit associated with the second operator.

Aspect 16: The method of Aspect 15, wherein the information indicating the random access resource comprises system information on a spectrum associated with the first operator.

Aspect 17: The method of Aspect 16, wherein the system information includes an indication that the second operator is permitted to use the random access resource.

Aspect 18: The method of Aspect 17, wherein the indication that the second operator is permitted to use the random access resource is separate from cell access related information of the system information.

Aspect 19: The method of any of Aspects 15-18, wherein transmitting the second random access message comprises transmitting a first second random access message associated with the first operator and a second second random access message associated with the second operator, wherein the second second random access message includes the indication of the second operator.

Aspect 20: The method of Aspect 19, wherein receiving the third random access message comprises receiving the third random access message in association with the second second random access message including the indication of the second operator.

Aspect 21: The method of any of Aspects 15-20, wherein the indication of the second operator comprises a set of network identifiers, wherein the set of network identifiers indicates the second operator.

Aspect 22: The method of any of Aspects 15-21, wherein the indication of the second operator comprises an identifier that is associated with a set of network identifiers, wherein the set of network identifiers indicates the second operator.

Aspect 23: The method of Aspect 22, further comprising transmitting information that indicates a mapping between the identifier and the set of network identifiers.

Aspect 24: The method of any of Aspects 15-23, wherein the indication of the second operator comprises an implicit indication of the second operator.

Aspect 25: The method of Aspect 24, wherein the implicit indication comprises at least one of a demodulation reference signal sequence or a radio network temporary identifier.

Aspect 26: The method of Aspect 24, further comprising transmitting information that indicates a mapping between the implicit indication and the second operator.

Aspect 27: The method of any of Aspects 15-26, wherein transmitting the information indicating the random access resource is in response to a trigger, associated with the first operator, to transmit the information indicating the random access resource.

Aspect 28: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-27.

Aspect 29: An apparatus for wireless communication at a device, the apparatus comprising one or more memories and one or more processors coupled to the one or more memories, the one or more processors configured to cause the device to perform the method of one or more of Aspects 1-27.

Aspect 30: An apparatus for wireless communication, the apparatus comprising at least one means for performing the method of one or more of Aspects 1-27.

Aspect 31: A non-transitory computer-readable medium storing code for wireless communication, the code comprising instructions executable by one or more processors to perform the method of one or more of Aspects 1-27.

Aspect 32: A non-transitory computer-readable medium storing a set of instructions for wireless communication, the set of instructions comprising one or more instructions that, when executed by one or more processors of a device, cause the device to perform the method of one or more of Aspects 1-27.

Aspect 33: A device for wireless communication, the device comprising a processing system that includes one or more processors and one or more memories coupled with the one or more processors, the processing system configured to cause the device to perform the method of one or more of Aspects 1-27.

Aspect 34: An apparatus for wireless communication at a device, the apparatus comprising one or more memories and one or more processors coupled to the one or more memories, the one or more processors individually or collectively configured to cause the device to perform the method of one or more of Aspects 1-27.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally or alternatively, a set of (one or more) components shown in FIG. 9 may perform one or more functions described as being performed by another set of components shown in FIG. 9.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Also, as used herein, the term “or” is intended to be inclusive when used in a series and may be used interchangeably with “and/or,” unless explicitly stated otherwise (for example, if used in combination with “either” or “only one of”). It should be understood that “one or more” is equivalent to “at least one.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. A user equipment (UE) for wireless communication, comprising:
a processing system that includes one or more processors and one or more memories coupled with the one or more processors, the processing system configured to cause the UE to:
receive, in association with a first operator, information indicating a random access resource, wherein the UE is associated with a second operator;
transmit a first random access message on the random access resource;
receive a second random access message; and
transmit, in association with the second random access message, a third random access message, wherein at least one of the second random access message or the third random access message is associated with an indication of the second operator.

2. The UE of claim 1, wherein the information indicating the random access resource comprises system information on a spectrum associated with the first operator.

3. The UE of claim 2, wherein the system information includes an indication that the second operator is permitted to use the random access resource.

4. The UE of claim 3, wherein the indication that the second operator is permitted to use the random access resource is separate from cell access related information of the system information.

5. The UE of claim 1, wherein, to cause the UE to receive the second random access message, the processing system is configured to cause the UE to receive a first second random access message associated with the first operator and a second second random access message associated with the second operator,
wherein the second second random access message includes the indication of the second operator.

6. The UE of claim 5, wherein, to cause the UE to transmit the third random access message, the processing system is configured to cause the UE to transmit the third random access message, in response to the second second random access message, in association with the second second random access message including the indication of the second operator.

7. The UE of claim 1, wherein the indication of the second operator comprises a set of network identifiers, wherein the set of network identifiers indicates the second operator.

8. The UE of claim 7, wherein a network identifier, of the set of network identifiers, matches a subscription or a random access cause of the UE.

9. The UE of claim 1, wherein the indication of the second operator comprises an identifier that is associated with a set of network identifiers, wherein the set of network identifiers indicates the second operator.

10. The UE of claim 9, wherein the processing system is further configured to cause the UE to receive information that indicates a mapping between the identifier and the set of network identifiers.

11. The UE of claim 1, wherein the indication of the second operator comprises an implicit indication of the second operator.

12. The UE of claim 11, wherein the implicit indication comprises at least one of a demodulation reference signal sequence or a radio network temporary identifier.

13. The UE of claim 11, wherein the processing system is further configured to cause the UE to receive information that indicates a mapping between the implicit indication and the second operator.

14. The UE of claim 1, wherein the random access resource is shared by the first operator and the second operator.

15. A network node for wireless communication, comprising:
a processing system that includes one or more processors and one or more memories coupled with the one or more processors, the processing system configured to cause the network node to:
transmit information indicating a random access resource shared by a first operator and a second operator;
receive a first random access message on the random access resource;
transmit a second random access message;
receive, in association with the second random access message, a third random access message, wherein at least one of the second random access message or the third random access message is associated with an indication of the second operator; and
provide the third random access message to a distributed unit associated with the second operator.

16. The network node of claim 15, wherein the information indicating the random access resource comprises system information on a spectrum associated with the first operator.

17. The network node of claim 16, wherein the system information includes an indication that the second operator is permitted to use the random access resource.

18. The network node of claim 17, wherein the indication that the second operator is permitted to use the random access resource is separate from cell access related information of the system information.

19. The network node of claim 15, wherein, to cause the network node to transmit the second random access message, the processing system is configured to cause the network node to transmit the second random access message comprises transmitting a first second random access message associated with the first operator and a second second random access message associated with the second operator,
wherein the second second random access message includes the indication of the second operator.

20. The network node of claim 19, wherein, to cause the network node to receive the third random access message, the processing system is configured to cause the network node to receive the third random access message in association with the second second random access message including the indication of the second operator.

21. The network node of claim 15, wherein the indication of the second operator comprises a set of network identifiers, wherein the set of network identifiers indicates the second operator.

22. The network node of claim 15, wherein the indication of the second operator comprises an identifier that is associated with a set of network identifiers, wherein the set of network identifiers indicates the second operator.

23. The network node of claim 15, wherein the indication of the second operator comprises an implicit indication of the second operator.

24. The network node of claim 15, wherein transmitting the information indicating the random access resource is in response to a trigger, associated with the first operator, to transmit the information indicating the random access resource.

25. A method of wireless communication at a user equipment (UE), comprising:
receiving, in association with a first operator, information indicating a random access resource, wherein the UE is associated with a second operator;
transmitting a first random access message on the random access resource;
receiving a second random access message; and
transmitting, in association with the second random access message, a third random access message, wherein at least one of the second random access message or the third random access message is associated with an indication of the second operator.

26. The method of claim 25, wherein the information indicating the random access resource comprises system information on a spectrum associated with the first operator.

27. The method of claim 26, wherein the system information includes an indication that the second operator is permitted to use the random access resource.

28. The method of claim 27, wherein the indication that the second operator is permitted to use the random access resource is separate from cell access related information of the system information.

29. A method of wireless communication at a network node, comprising:
transmitting information indicating a random access resource shared by a first operator and a second operator;
receiving a first random access message on the random access resource;
transmitting a second random access message;
receiving, in association with the second random access message, a third random access message, wherein at least one of the second random access message or the third random access message is associated with an indication of the second operator; and
providing the third random access message to a distributed unit associated with the second operator.

30. The method of claim 29, wherein the information indicating the random access resource comprises system information on a spectrum associated with the first operator.
